(19) United States
(12) Patent Application Publication
(10) Pub. No.: US 2011/0286606 A1
(43) Pub. Date: Nov. 24, 2011

(54) METHOD AND SYSTEM FOR NOISE CANCELLATION

(76) Inventors: Khaldoon Taha Al-Naimi, Surrey (GB); Robert Dobson, Edinburgh (GB)

(21) Appl. No.: 13/147,423

(22) PCT Filed: Feb. 18, 2010
(86) PCT No.: PCT/GB2010/050277

§ 371 Date: Aug. 2, 2011

(30) Foreign Application Priority Data
Feb. 20, 2009 (GB) 0902869.7
Feb. 25, 2009 (GB) 0903154.3
Jun. 5, 2009 (GB) 090690.0

(51) Int. Cl. G10K 11/16

(52) U.S. Cl. 381/71.1

(57) ABSTRACT

A noise cancellation signal is generated based on detected ambient noise, such that the noise cancellation signal and a wanted sound signal can be applied to a speaker. Gain control is applied to the wanted sound signal based on a comparison between the detected ambient noise level and the wanted sound signal level, for example such that the level of the wanted sound signal after the gain has been applied exceeds the level of a detected ambient noise signal by a certain threshold. Steps may also be taken such that the total level of the wanted sound signal after the gain has been applied and of the detected ambient noise signal do not exceed a second threshold, to avoid saturating the speaker to which they are applied.

### FIELD OF THE INVENTION

This invention relates to a noise cancellation system, for use in a sound reproduction system, and to a method and system for improving the intelligibility of the speech or other output from the sound reproduction system.

### BACKGROUND OF THE INVENTION

Speech intelligibility is greatly affected by the increase in noise power in the user's environment. This makes the conversation harder to understand for the user in the noisy place and therefore will start shouting, making it uncomfortable for the user on the other end. Speech clarity is an automatic gain control system used to improve the user experience in such noisy conditions. When the system detects that the ambient noise power is increasing, it will increase the downlink speech power such that a fixed speech signal to noise signal power ratio is maintained (i.e. a fixed SNR value which is a system parameter setup).

### SUMMARY OF THE INVENTION

According to a first aspect of the present invention, there is provided a method for noise cancellation, the method comprising the steps of: detecting ambient noise; generating a noise cancellation signal on the basis of said detected ambient noise; applying gain control to a wanted sound signal based on the detected ambient noise;

and applying the noise cancellation signal and the gain controlled wanted sound signal to a speaker.

According to a second aspect of the present invention, there is provided a system for noise cancellation, the system comprising: an output for receiving a detected ambient noise signal; a microprocessor for generating a noise cancellation signal on the basis of the received detected ambient noise signal; a variable gain amplifier for applying gain control to the wanted sound signal based on the detected ambient noise signal; and an adder for summing the noise cancellation signal and the gain controlled wanted sound signal to provide an output signal for output to a speaker.

The microprocessor may be adapted to generate the noise cancellation signal by signal processing of the detected noise signal.

The microprocessor may be adapted to generate the noise cancellation signal by adaptive signal processing of the detected noise signal.

The system may further comprise a first decimator adapted to decimate the detected noise signal and the microprocessor may be adapted to perform the adaption of the signal processing by applying the decimated detected noise signal to an emulation of the signal processing to achieve desired properties, and the variable gain amplifier may be adapted to apply the gain control to the wanted sound signal based on the decimated detected noise signal.

The system may further comprise a second decimator adapted to decimate the wanted sound signal, and the variable gain amplifier may be adapted to apply the gain control to the wanted sound signal based on the decimated detected noise signal and the decimated wanted sound signal.

The variable gain amplifier may be adapted to apply gain control to the wanted sound signal such that the level of the wanted sound signal after the gain has been applied exceeds the level of the detected ambient noise signal by a certain threshold.

The variable gain amplifier may be adapted to reduce the gain applied to the wanted sound signal when the level of the wanted sound signal after the gain has been applied exceeds the level of the detected ambient noise signal by the certain threshold, and the variable gain amplifier may be adapted to increase the gain applied to the wanted sound signal when the level of the wanted sound signal after the gain has been applied does not exceed the level of the detected ambient noise signal by the certain threshold.

The variable gain amplifier may be adapted to apply changes to the gain incrementally.

The variable gain amplifier may be adapted to apply hysteresis to changes in the gain.

The adder may be adapted to ensure that the total level of the wanted sound signal after the gain has been applied and of the detected ambient noise signal do not exceed a second threshold, to avoid saturating the speaker to which they are applied.

Such a speech clarity system is based on simplicity of the design such that the best effect is achieved while not adding a huge burden on the associated processor if implemented as software for example. It will be appreciated that the speech clarity system herein illustrated may be implemented in software, hardware or in a combination of software and hardware.

### BRIEF DESCRIPTION OF THE DRAWINGS

For a better understanding of the invention, and to show more clearly how it may be carried into effect, reference will now be made, by way of example only, to the accompanying drawings in which:

FIG. 1 shows an overall system block diagram of a noise cancellation system including a speech clarity system in accordance with the invention;

FIG. 2 shows the speech clarity system in more detail;

FIG. 3 shows an alternative form of the speech clarity system;

FIG. 4 shows the structure of a high pass filter of the speech clarity system of FIGS. 2 and 3;

FIG. 5 shows the structure of an envelope follower of the speech clarity system of FIGS. 2 and 3;

FIG. 6 shows the structure of a low pass filter of the envelope follower of FIG. 5;

FIG. 7 shows the structure of an SNR block of the speech clarity system of FIG. 2;

FIG. 8 illustrates the VAD block in the SNR block of FIG. 7;

FIG. 9 shows the structure of an SNR block of the speech clarity system of FIG. 3;

FIG. 10 illustrates the SNR control block in the SNR block of FIG. 7 or FIG. 9; and

FIG. 11 illustrates the gain estimation block in the speech clarity system of FIG. 2 or FIG. 3.

### DETAILED DESCRIPTION

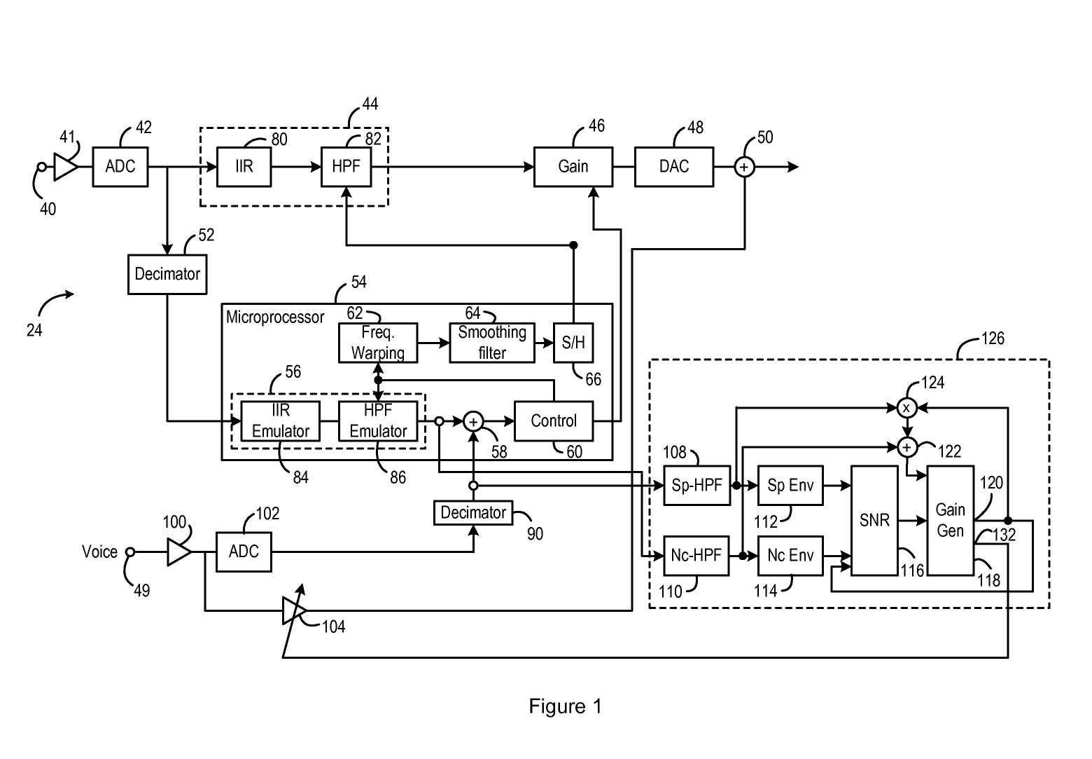

FIG. 1 shows a noise cancellation system 24. It is known that there are many types of noise cancellation system, and hence FIG. 1 is provided only as an illustration of one such system, in order to indicate how the invention may be applied. The noise cancellation system of FIG. 1 is a feedforward noise cancellation system, in which the noise cancellation signal processing is adaptive. As mentioned above, the invention is equally applicable to other types of system. In this illustrated embodiment of the invention, the adaption of the noise cancellation processing is performed by digitizing the ambient noise signal and the wanted voice signal, and decimating them to achieve lower sample rates, and then performing a lower rate emulation to determine the effect of the signal processing. In this illustrated embodiment of the invention, the decimated ambient noise signal and the decimated version wanted speech signal are used as inputs to the speech clarity block. Again, other arrangements are possible. For example, the speech clarity block could operate on the ambient noise signal and the wanted speech signal themselves. In this illustrated embodiment, the output gain value is applied as a control signal to a variable gain amplifier in the speech path.

The system is described in more detail with reference to various Figures that illustrate particular embodiments of the invention. It will be appreciated that the details shown in these Figures, in particular specific values for thresholds or other parameters, and given here by way of example only, and are not intended to place limits on the scope of the invention.

FIG. 1 shows an example of the form of a noise cancellation system, for example for use in a handset or other sound reproduction device, including the speech clarity system 126 of the invention.

With reference to FIG. 1, a first input 40 is connected to receive an input signal, for example, directly from a microphone. This input signal is amplified in an amplifier 41 and the amplified signal is applied to an analog-digital converter 42, where it is converted to a digital signal. The resulting digital signal is then applied to an adaptive digital filter 44. The digital filter 44 comprises a fixed stage 80, taking the form of a sixth-order IIR filter, and an adaptive stage 82, taking the form of a high-pass filter. The resulting filtered signal from the adaptive digital filter 44 is applied to an adaptive gain device 46. The filtering and level adjustment applied by the filter 44 and the gain device 46 are intended to generate a noise cancellation signal that allows the detected ambient noise to be cancelled when played through a speaker that is positioned close to the ear of the user.

The noise cancellation signal is produced from the input signal by the adaptive digital filter 44 and the adaptive gain device 46. These are controlled by one or more control signals, which are generated by applying the digital signal output from the analog-digital converter 42 to a decimator 52 which reduces the digital sample rate, and then to a microprocessor 54.

The microprocessor 54 contains a block 56 that emulates the filter 44 and gain device 46. The block 56 contains a fixed stage 84 and an adaptive stage 86, taking the form of a high-pass filter, whose filter characteristic can be adapted in use based on the output of the control block 60.

The block 56 produces an emulated filter output which is applied to an adder 58, where it is summed with a wanted speech signal from the second input 49. The second input receives the wanted speech signal and the wanted speech signal is applied to an amplifier 100. The amplified signal is applied to an analog-digital converter 102, where it is converted to a digital signal, and this digital signal is applied to the adder 58 via a decimator 90. The sample rate reduction performed by the decimators 52, 90 allows the emulation to be performed with lower power consumption than performing the emulation at the original sample rate.

The resulting signal from the adder 58 is applied to a control block 60, which generates control signals for adjusting the properties of the filter 44 and the gain device 46. The control signal for the filter 44 is applied through a frequency warping block 62, a smoothing filter 64 and sample-and-hold circuitry 66 to the filter 44. The same control signal is also applied to the block 56, so that the emulation of the filter 44 matches the adaptation of the filter 44 itself.

The purpose of the frequency warping block 62 is to adapt the control signal output from the control block 60 for the high-frequency adaptive filter 82.

The smoothing filter 64 smoothes out any ripples in the control signal generated by the control block 60, such that noise in the system is reduced.

The control block 60 further generates a control signal for the adaptive gain device 46.

The output signal of the adaptive gain device 46 is applied to a digital-analog converter 48, where it is converted to an analog signal.

As mentioned above, the second input 49 is connected to receive a wanted speech signal. For example, where the invention is to be implemented in a mobile phone, the second input 49 can be connected to the output of the baseband processing chip in the mobile phone. Of course, in other systems, this wanted signal may represent not only speech, but music or any other wanted signal, and may be received in digital form, for example. The wanted speech signal is applied to an amplifier 100. This amplified signal is also applied to a variable gain amplifier 104. The variable gain amplifier 104 is controlled by an output signal from the speech clarity system 126.

The output signal of the variable gain amplifier 104 is applied to an adder 50, where it is summed with the resulting analog signal received from the digital-analog converter 48.

The output signal from the adder 50 can then be applied to a speaker. For example, where the invention is implemented in a mobile phone or other handset, the output signal from the adder 50 can be applied to the speaker in the handset.

The invention proceeds from the recognition that, where the device is being used in a noisy environment, it can improve the user's listening experience if the volume of the wanted signal is increased.

As shown in FIG. 1, the output signal from the decimator 90, namely a digitized and decimated version of the wanted speech signal, and the output signal from the filter emulator 56, namely a signal representing the generated noise cancellation signal, are applied to a speech clarity processing block 126. The speech clarity processing block 126 generates an output signal in the form of a control signal, which is applied to the controllable amplifier 104, in order to adjust the gain applied to the wanted speech signal.

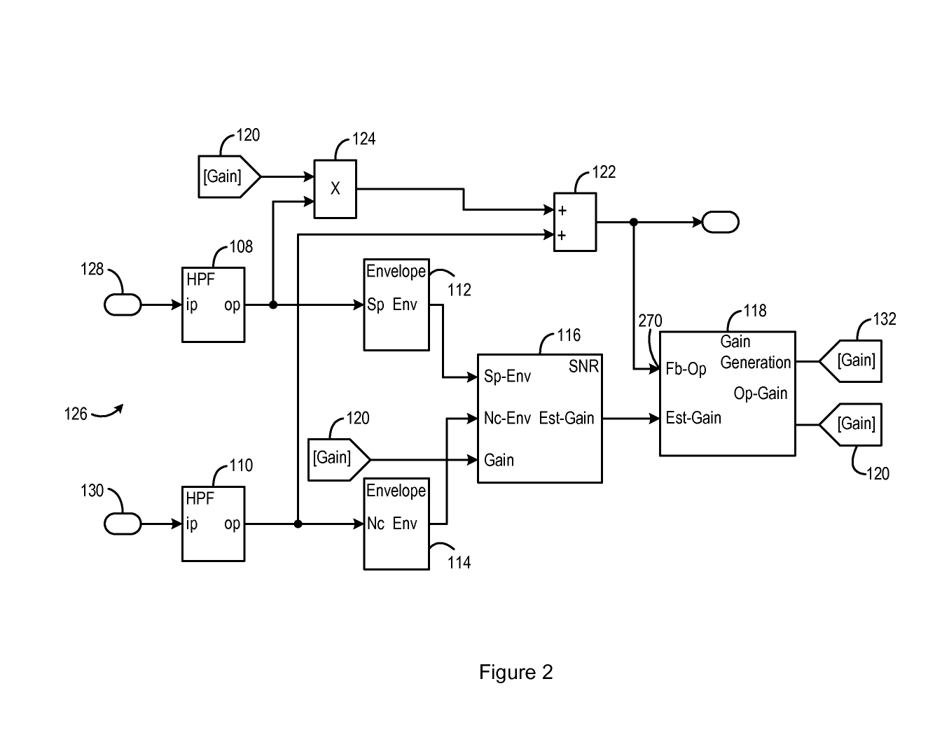

FIG. 2 shows in more detail the form of the speech clarity system 126 according to one embodiment of the invention.

A first input terminal 128 of the speech clarity system 126 is connected to receive the output speech signal from the decimator 90. This received speech signal is applied to a first high pass filter 108, which removes the DC that is introduced due to the decimator and gain stages.

Similarly, a second input terminal 130 of the speech clarity system 126 is connected to receive the emulated filter output from block 56. This emulated filter output is applied to a second high pass filter 110, which removes the DC that is introduced due to the respective decimator and gain stages.

The output of the first high pass filter 108 is applied to a speech envelope detector 112. Similarly, the output of the second high pass filter 110 is applied to a noise envelope detector 114.

The speech envelope output of the speech envelope detector 112 and the noise envelope output of the noise envelope detector 114 are applied to a signal-to-noise ratio (SNR) block 116. A current value for the gain applied to the wanted speech signal is also applied to the SNR block 116. The SNR block 116 compares the speech envelope signal to the noise envelope signal and, based also on the current value for the gain, outputs a prediction of the gain needed to maintain a pre-set SNR threshold.

The gain prediction output from the SNR block 116 is applied to a gain generation block 118, and the gain generation block 118 generates an output gain control signal on a first output line 132, such that it can be applied as a control signal to the variable gain amplifier 104.

The gain generation block 118 also generates an output gain value on a second output line 120. The gain value generated on the second output line 120 preferably has the same value as the gain generated by the variable gain amplifier 104 in response to the gain control signal on the first output line 132. The output gain value generated on the second output line 120 is fed back as an input to the SNR block 116. In this way, the SNR block 116 receives a current value for the gain applied to the wanted speech signal.

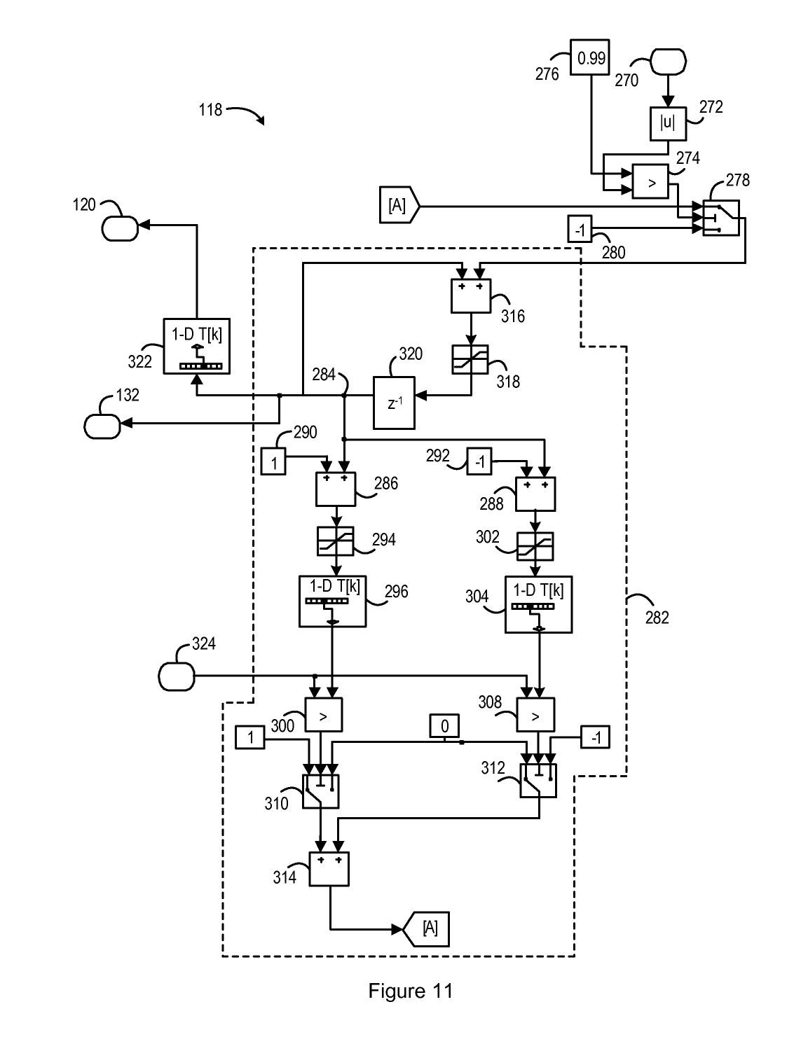

The output gain value generated on the second output line 120 is also applied as one input to a multiplier 124, which receives the output of the first high pass filter 108 as its second input, such that the multiplier 124 generates an output signal that emulates the output of the digital-analog converter 48. The output of the multiplier 124 is applied to one input of an adder 122. At the same time, the output of the first high pass filter 108 is applied to a second input of the adder 122, such that the output of the adder 122 emulates the signal that is applied from the adder 50 to the speaker. The emulated signal Fb-Op from the output of the adder 122 is applied to a first input 270 of the gain generation block 118. The input Fb-Op represents the current value of the signal applied to the speaker of the device, and takes account of the fact that the signal applied to the speaker should not exceed a certain maximum amplitude, to avoid clipping or other distortion (as will be described in more detail below, with reference to FIG. 11).

As will be described in more detail below, the system shown in FIG. 2 is able to make an estimation of time periods during which the user of the device is speaking, and of time periods during which the wanted speech signal contains speech, the latter being distinguished from time periods during which the wanted speech signal contains only background noise from the far end of the communications channel.

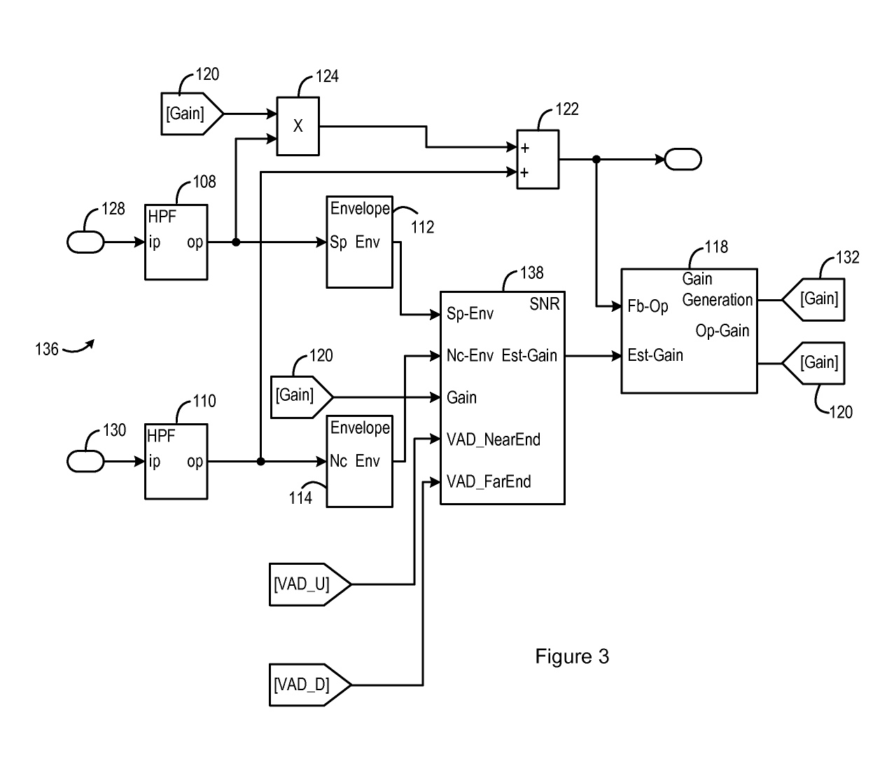

FIG. 3 shows an alternative form of the speech clarity block, for use in a device in which signals indicating these time periods are already available from other sources. Thus, the speech clarity block 136 shown in FIG. 3 is the same as the speech clarity block 126 shown in FIG. 2, except that the SNR block 138 receives a first additional input in the form of a Voice Activity Detection signal VAD_U, indicating the presence or absence of speech in the uplink, i.e. the speech of the user of the device in the signal detected by the ambient noise microphone and present on the input 40, and a second additional input in the form of a Voice Activity Detection signal VAD_D, indicating the presence or absence of speech in the downlink, i.e. in the wanted voice signal received at the input 49.

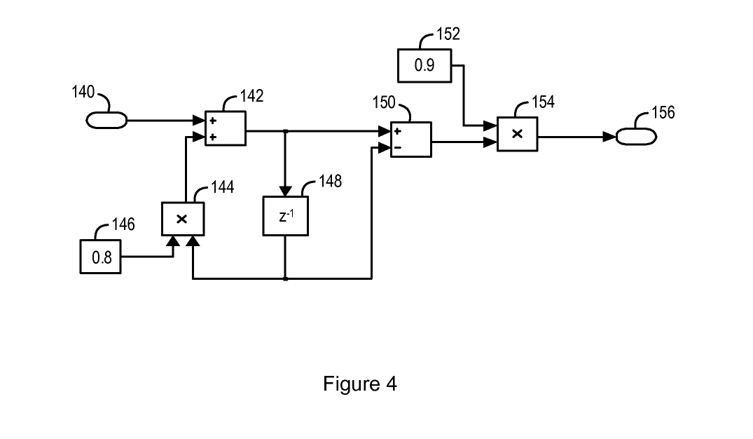

The speech clarity block 126 shown in FIG. 2 and the speech clarity block 136 shown in FIG. 3 each contain two high-pass filters 108, 110, the structures of which are shown in more detail in FIG. 4.

The input 140 of each high pass filter is connected to receive the respective input signal. Thus, the high-pass filters 108 are connected to receive the output speech signal from the decimator 90, while the high-pass filters 110 are connected to receive the emulated noise cancellation signal from the filter emulation block 56.

The received input signal in each case is applied to a first input of an adder 142. The output signal of the adder 142 is applied to a delay 148, which delays the output signal. The delayed output signal is applied to a multiplier 144, where it is multiplied by a parameter that is set in a block 146 and that, in this illustrated example, takes a value 0.8. The output of the multiplier 144 is applied to a second input of the adder 142, where it is summed with the output speech signal from the decimator 90.

The output signal from the adder 142 and the delayed output signal from the delay 148 are also applied to a subtractor 150, such that the subtractor 150 generates an output signal in which the delayed output signal from the delay 148 is subtracted from the output signal from the adder 142. The output signal from the subtractor 150 is applied to a multiplier 154, where it is normalized by multiplication with a parameter obtained from an input 152 that, in this embodiment, is 0.9. The output signal from the multiplier 154 is applied to the output 156 of the respective high pass filter 108, 110.

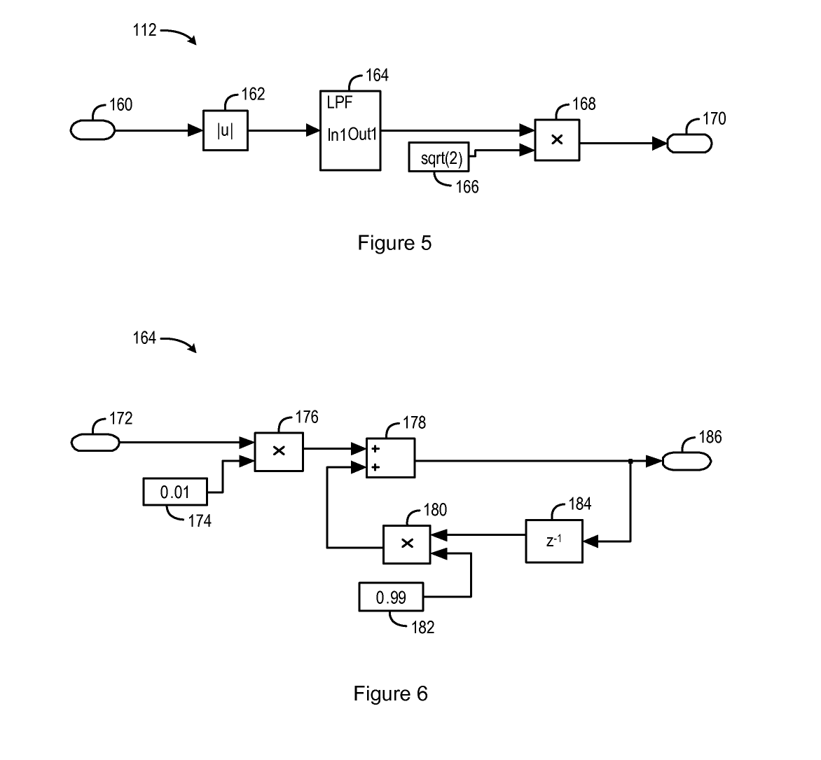

The structure of the speech envelope followers 112 in FIGS. 2 and 3 is shown in more detail in FIG. 5, and the structure of the noise envelope followers 114 is the same. With reference to FIG. 5, the input 160 of the envelope follower 112 is connected to receive as its input an output signal from the high pass filter 108. Similarly the envelope follower 114 receives as its input an output signal from the high pass filter 110. The received input signal is applied to block 162, which takes the absolute value of the received output signal. The output signal from block 162 is applied to a low pass filter 164 and the output signal from the low pass filter 164 is applied to a multiplier 168, where it is multiplied by a value of sqrt(2) applied from block 166. A value of sqrt(2) is chosen to approximately recreate the signal power but an alternative value may be used. The output signal from the multiplier 168 is applied to the output 170 of the envelope follower 112.

The low pass filter 164 in the envelope followers 112, 114 is shown in more detail in FIG. 6. With reference to FIG. 6, the input 172 is connected to receive the absolute value of the input signal, as generated by the block 162. This received signal is applied to a multiplier 176, where it is multiplied by a parameter that is applied from block 174 and that in this illustrated embodiment takes a value of 0.01. The output signal from the multiplier 176 is applied to a first input of an adder 178. The output signal from the adder 178 is applied to a delay 184, and the delayed signal is applied to a multiplier 180, where it is multiplied by a parameter that is applied from block 182, and that in this illustrated embodiment takes a value of 0.99. The output signal from the multiplier 180 is applied to a second input of the adder 178. In this illustrated embodiment, the parameter that is applied from block 174 takes a value of 0.01 and the parameter that is applied from block 182 takes a value of 0.99 but the parameters may take different values. Preferably, the sum of the parameters that are applied from block 174 and block 182 is 1.

The output signal from the adder 178 is applied to the output 186 of the low pass filter 164.

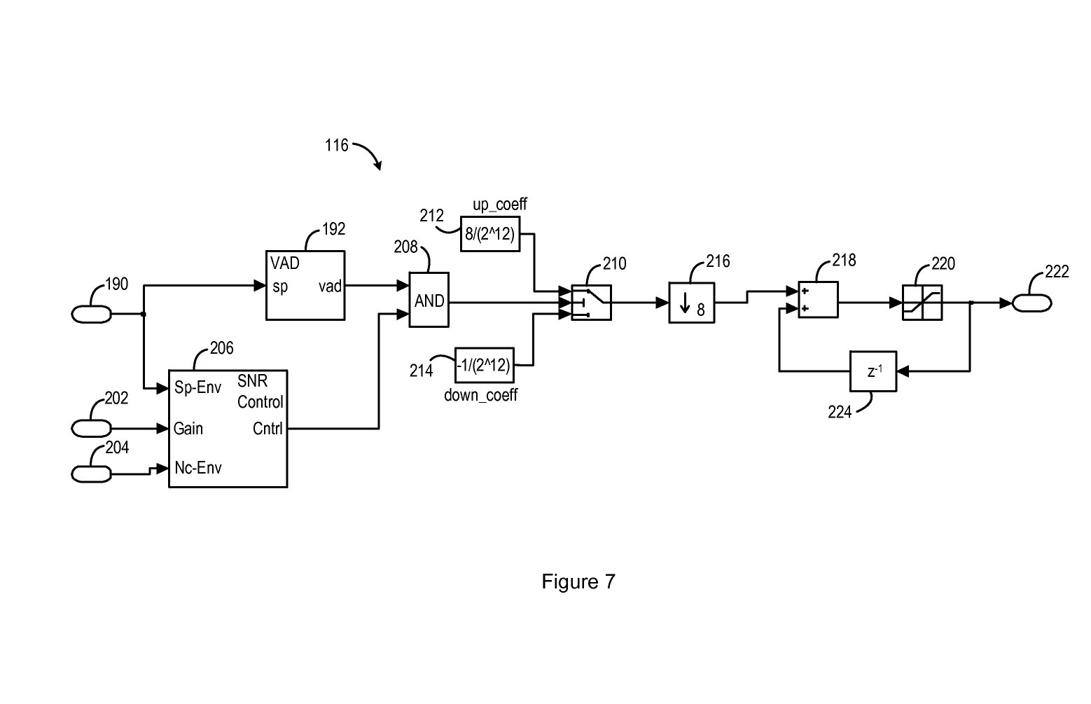

FIG. 7 shows in more detail the structure of the SNR block 116 in the system 126 of FIG. 2.

The SNR block 116 receives on one input 190 the speech envelope signal generated by the speech envelope detection block 112. The speech envelope signal is applied to a Voice Activity Detection (VAD) block 192. The purpose of the VAD block 192 is to detect when the wanted speech signal actually contains speech, and does not contain only background noise. This is because it may be preferable in some situations to control the gain applied to the wanted speech signal only when this signal does actually contain speech.

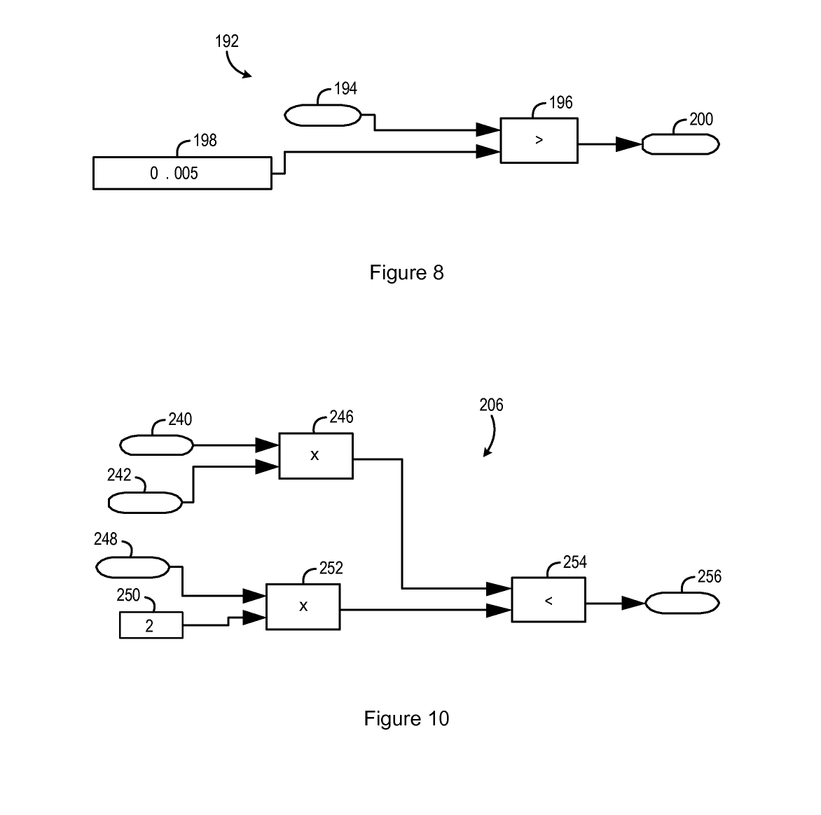

The structure of the VAD block 192 is shown in more detail in FIG. 8. In this case, the operation of the VAD block 192 is relatively straightforward, in that the speech envelope signal is received on an input 194, and is compared in a comparator 196 with a threshold value that is received from a block 198 and that in this illustrated embodiment takes the value 0.005. Thus, the VAD block 192 generates a positive signal on its output 200 only when the level of the speech envelope signal exceeds this threshold.

It is known that other methods are available for detecting voice activity in a signal, and these may be used in this system if desired.

Returning to FIG. 7, the SNR block 116 receives on a second input 202 the fed back signal representing the current value of the gain being applied to the wanted voice signal, and receives on a third input 204 the noise envelope signal generated by the noise envelope detection block 114.

The signals received on the first input 190, the second input 202 and the third input 204 of the SNR block 116 are applied to an SNR control block 206, which generates a signal indicating whether further control of the gain applied to the wanted speech signal appears necessary. As described in more detail below, the SNR control block 206 does not generate a positive signal at times when the current speech envelope, multiplied by the current gain value, already exceeds the current noise envelope by some predetermined margin.

The output VAD signal, and the output signal from the SNR control block 206, are applied to an AND gate 208. When the VAD signal and the output from the SNR control block 206 both indicate that an increase of the gain value would be desirable, a high level signal is output from the AND gate 208, and otherwise a low level signal is output from the AND gate 208.

The output signal from the AND gate 208 is applied to a switch 210. When the switch 210 receives a high level signal, it selects as its output a parameter value (up_coeff) received from an input 212, which in this illustrated embodiment takes the value 8/2¹².

By contrast, when the switch 210 receives a low level signal, it selects as its output a parameter value (down_coeff) received from an input 214, which in this illustrated embodiment takes the value −1/2¹². In this way, any required changes in the gain are applied incrementally.

The output of the switch 210 is applied to a downsampling block 216, which decimates the signal by a decimation factor of 8. This has the effect of controlling the rate at which the gain can be adjusted.

The output of the block 216 is applied to a first input of an adder 218, the output of which is applied to a saturation block 220, which ensures that the resultant signal does not exceed a predetermined maximum value, and is then applied to an output terminal 222 of the SNR block 116.

The output signal is also applied to a delay block 224, and the delayed signal is applied to a second input of the adder 218. The result is that, assuming that there are no issues of saturation, the current output of the SNR block is equal to the previous output, either increased by the value of the parameter up_coeff or reduced by the value of the parameter down_coeff, depending on whether the signals applied to the AND gate 208 indicate that an increase of the gain value would be desirable.

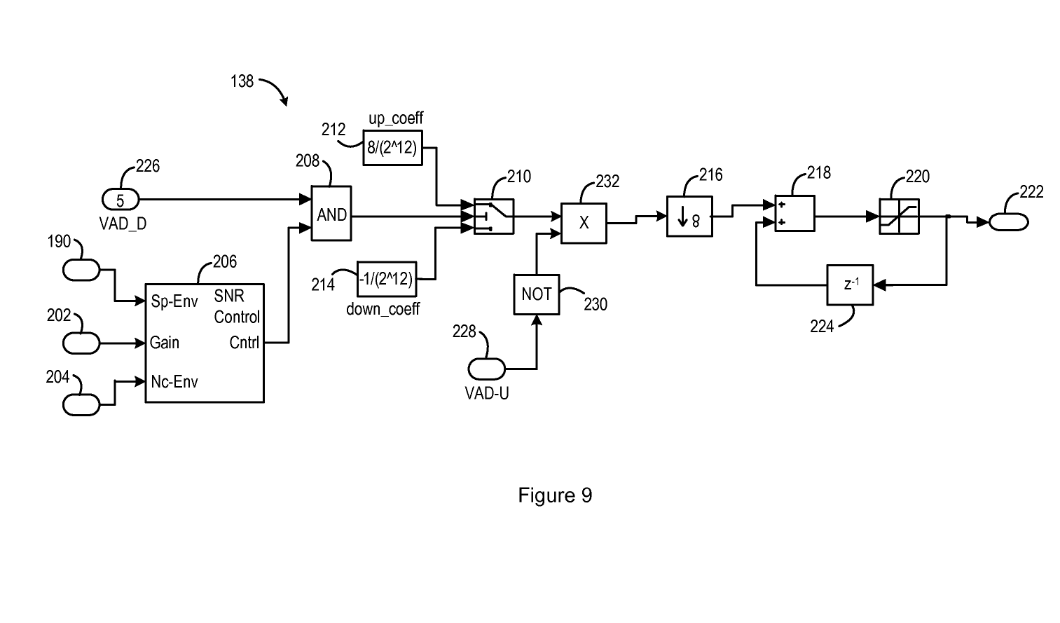

FIG. 9 shows an alternative form of the SNR block, for use in the situation where there are uplink and downlink VAD signals already available, as shown in FIG. 3. The SNR block 138 shown in FIG. 9 is generally similar to the SNR block 116, and component blocks that are the same as component blocks of the SNR block 116 are indicated by the same reference numerals that are used in FIG. 7, and will not be described in further detail.

In the SNR block 138 shown in FIG. 9, an additional input 226 receives the Voice Activity Detection signal VAD_D, indicating the presence or absence of speech in each frame of the downlink signal, i.e. in the wanted voice signal received at the input 49. The downlink Voice Activity Detection signal VAD_D, and the output signal from the SNR control block 206, are then applied to the AND gate 208, which operates in the same way as the AND gate 208 in FIG. 7.

A further additional input 228 receives the Voice Activity Detection signal VAD_U, indicating the presence or absence of speech in the uplink, that is, indicating whether the user of the handset is speaking at that particular time. Various techniques are known for determining whether a signal detected by a microphone contains speech. One possible technique that can be used in this case is to assume that there is speech in only one of the uplink and the downlink at any one time.

The Voice Activity Detection signal VAD_U is applied to a NOT gate 230, which inverts it, and the resulting signal is applied to a multiplier 232, which also receives the signal output from the switch 210. Thus, in this case, the signal from the switch 210 is applied to the downsampling block 216 only when the Voice Activity Detection signal VAD_U is low, indicating the absence of speech in the uplink. When that is the case, the SNR block 138 operates in the same way as the SNR block 116 shown in FIG. 7.

FIG. 10 shows in more detail the structure of the SNR control block 206, shown in FIGS. 7 and 9. Specifically, the signal received on the first input 190 of the SNR block 116 or 138, representing the speech envelope, is received on a first input 240 of the SNR control block 206. The signal received on the second input 202 of the SNR block 116 or 138, representing the current gain value, is received on a second input 242 of the SNR control block 206. These two signals are applied to a first multiplier 246.

Thus, the first multiplier 246 generates an output signal that represents the effect of applying the current gain value to the speech envelope.

The signal received on the third input 204 of the SNR block 116 or 138, representing the noise envelope, is received on a third input 248 of the SNR control block 206. A parameter value, which in this illustrated embodiment is equal to 2, is available on a fourth input 250 of the SNR control block 206. The signal received on the third input 248 and the parameter value available on the fourth input 250 are applied to a second multiplier 252.

Thus, the second multiplier 252 generates an output signal that is equal to a multiple of the noise envelope level, in this illustrated case at twice the noise envelope level, or 6 dB higher than the noise envelope level.

The output signals from the first multiplier 246 and the second multiplier 252 are applied to a comparator 254, which generates a positive output signal at the output terminal 256 of the SNR control block 206 when the signal from the first multiplier 246, representing the effect of applying the current gain value to the speech envelope, is lower than the signal from the second multiplier 252.

Thus, as described above, when it is determined that the effect of the current value of the gain is that the resulting amplified speech signal already exceeds the noise level by a predetermined amount, the signal applied from the SNR control block 206 to the AND gate 208 means that the amount of gain will only be reduced, and not increased.

FIG. 11 indicates in more detail the structure of the gain generation block 118 in the speech clarity system of FIG. 2 or FIG. 3. In general terms, the gain generation block 118 ramps up or ramps down the speech gain control on the basis of the output received from the SNR block 116 or 138.

The gain generation block 118 operates on the basis of a look-up table, in which increasing index values indicate increasing gain values. The gain generation block then operates to introduce a level of hysteresis, such that the gain value cannot fluctuate too quickly, as that might introduce audible changes in the gain.

In addition, as described above, the gain generation block 118 also takes account of the fact that the signal applied to the speaker should not exceed a certain maximum amplitude, to avoid clipping or other distortion. Specifically, the gain generation block 118 receives on a first input 270 the signal Fb-Op that is generated by the adder 122 shown in FIGS. 2 and 3, and which represents the current value of the signal applied to the speaker of the device. This signal is applied to a block 272, which forms the absolute value thereof, and then to a comparator 274, where it is compared with a parameter value available on an input 276, which in this illustrated embodiment takes the value 0.99.

When the absolute value of the signal Fb-Op exceeds the parameter value, indicating that the signal level applied to the speaker may be in danger of becoming too high, the comparator 274 controls a switch 278, such that it outputs a value received from an input 280, which tends to reduce the output gain value, as will be described in more detail below, and which in this case takes the value −1.

When the absolute value of the signal Fb-Op is lower than the parameter value, the comparator 274 controls a switch 278, such that it outputs a value [A], which is then used to control the output gain value, as will be described in more detail below.

The value [A] is obtained from a hysteresis section 282 of the gain generation block 118, as will be described in more detail below.

A gain index value, that is, a value indicating a gain value in the look-up table mentioned above, is present at point 284 in the hysteresis section, and this is applied to a first adder 286 and a second adder 288. In the first adder 286, the value 1 is added from point 290. The result is an index value that is higher by 1 than the gain value at point 284. Similarly, in the second adder 288, the value −1 is added from point 292. The result is an index value that is lower by 1 than the gain value at point 284.

The increased index value from the first adder 286 is applied to a saturation block 294, which ensures that the increased index value is not higher than the highest possible index value, and the result is input to a look-up table 296, which outputs the gain value corresponding to that increased index value. That gain value is applied to a first input of a first comparator 300.

The decreased index value from the second adder 288 is applied to a saturation block 302, which ensures that the decreased index value is not lower than the lowest possible index value, and the result is input to a look-up table 304, equivalent to the look-up table 296, which outputs the gain value corresponding to that decreased index value. That gain value is applied to a first input of a second comparator 308.

At the same time, the gain value generated by the SNR block 116 or 138 is applied at an input 324 of the gain generation block 118. This gain value is applied to second inputs of the first comparator 300 and the second comparator 308.

The first comparator 300 and the second comparator 308 control respective switches 310, 312, to select between the constant values available on the inputs of those switches. Thus, the first comparator 300 controls the switch 310 to output the value 1 if and only if the gain value generated by the SNR block 116 or 138 is greater than the gain value corresponding to the increased index value. Otherwise, the first comparator 300 controls the switch 310 to output the value 0. Similarly, the second comparator 308 controls the switch 312 to output the value −1 if and only if the gain value generated by the SNR block 116 or 138 is lower than the gain value corresponding to the decreased index value. Otherwise, the second comparator 308 controls the switch 312 to output the value 0. The outputs of the switches 310, 312 are applied to an adder 314, and the output of the adder 314 forms the value [A] mentioned above.

Thus, the hysteresis section 282 operates by comparing the input gain value generated by the SNR block with the gain values from the look-up table that are higher and lower than the current gain value. A non-zero value of [A], which will have the effect of changing the gain value, will be generated only if the input gain value generated by the SNR block falls outside the range defined by the gain values from the look-up table that are higher and lower than the current gain value. This prevents fluctuations in the gain value that may be audible.

As mentioned above, the absolute value of the signal Fb-Op may exceed a parameter value, indicating that the signal level applied to the speaker may be in danger of becoming too high, in which case the switch 278 outputs a value of −1, but in the more normal case the switch 278 outputs the value [A].

The output from the switch 278 is applied to one input of an adder 316, which receives the index value at point 284 on its other input. Thus, assuming that the signal Fb-Op is not indicating a risk of saturation, the value of [A] is used to increment or decrement the current index value when it takes a non-zero value.

The output of the adder 316 is applied through a saturation block 318 to ensure that it is not above the maximum possible value or below the minimum possible value, and is then applied to a delay block 320 so that it forms the index value in the next cycle.

Meanwhile, the index value at the point 284 in the present cycle is applied to the first output line 132, from which it can be used to control the gain of the amplifier 104 as discussed previously.

The index value at the point 284 in the present cycle is also applied to a look-up table 322 included in the software of the speech clarity system 126 to generate a gain value on the second output line 120. The gain value generated on the second output line 120 has the same value as the gain value generated in the variable gain amplifier 104 by the gain control signal on the first output line 132.

There is thus disclosed a system for controlling the gain of an amplifier, in particular an amplifier in the wanted speech path in a system including noise cancellation.

1. A method for noise cancellation, the method comprising the steps of: detecting ambient noise;
generating a noise cancellation signal on the basis of said detected ambient noise;
applying gain control to a wanted sound signal based on the detected ambient noise; and
applying the noise cancellation signal and the gain controlled wanted sound signal to a speaker.

2. A method as claimed in claim 1, wherein the ambient noise is detected to produce a detected noise signal, and the noise cancellation signal is generated by signal processing of the detected noise signal.

3. A method as claimed in claim 1, wherein the noise cancellation signal is generated by adaptive signal processing of the detected noise signal.

4. A method as claimed in claim 3, wherein the adaption of the signal processing is performed by decimating the detected noise signal and applying the decimated detected noise signal to an emulation of the signal processing to achieve desired properties, and wherein the gain control is applied to the wanted sound signal based on the decimated detected noise signal.

5. A method as claimed in claim 4, wherein the wanted sound signal is decimated, and gain control is applied to the wanted sound signal based on the decimated detected noise signal and the decimated wanted sound signal.

6. A method as claimed in claim 1, comprising applying gain control to the wanted sound signal such that the level of the wanted sound signal after the gain has been applied exceeds the level of the detected ambient noise signal by a certain threshold.

7. A method as claimed in claim 6, comprising reducing the gain applied to the wanted sound signal when the level of the wanted sound signal after the gain has been applied exceeds the level of the detected ambient noise signal by the certain threshold, and increasing the gain applied to the wanted sound signal when the level of the wanted sound signal after the gain has been applied does not exceed the level of the detected ambient noise signal by the certain threshold.

8. A method as claimed in claim 7, comprising applying changes to the gain incrementally.

9. A method as claimed in claim 7, comprising applying hysteresis to changes in the gain.

10. A method as claimed in claim 6, further comprising ensuring that the total level of the wanted sound signal after the gain has been applied and of the detected ambient noise signal do not exceed a second threshold, to avoid saturating the speaker to which they are applied.

11. A system for noise cancellation, the system comprising:
an input for receiving a detected ambient noise signal;
a microprocessor for generating a noise cancellation signal on the basis of the received detected ambient noise2 signal;
a variable gain amplifier for applying gain control to the wanted sound signal based on the detected ambient noise signal; and
an adder for summing the noise cancellation signal and the gain controlled wanted sound signal to provide an output signal for output to a speaker.

12. A system as claimed in claim 11 , wherein the microprocessor is adapted to generate the noise cancellation signal by signal processing of the detected noise signal.

13. A system as claimed in claim 11 , wherein the microprocessor is adapted to generate the noise cancellation signal by adaptive signal processing of the detected noise signal.

14. A system as claimed in claim 13, further comprising a first decimator adapted to decimate the detected noise signal and wherein the microprocessor is adapted to perform the adaption of the signal processing by applying the decimated detected noise signal to an emulation of the signal processing to achieve desired properties, and wherein the variable gain amplifier is adapted to apply the gain control to the wanted sound signal based on the decimated detected noise signal.

15. A system as claimed in claim 14, further comprising a second decimator adapted to decimate the wanted sound signal, and wherein the variable gain amplifier is adapted to apply the gain control to the wanted sound signal based on the decimated detected noise signal and the decimated wanted sound signal.

16. A system as claimed in claim 11, wherein the variable gain amplifier is adapted to apply gain control to the wanted sound signal such that the level of the wanted sound signal after the gain has been applied exceeds the level of the detected ambient noise signal by a certain threshold.

17. A system as claimed in claim 16, wherein the variable gain amplifier is adapted to reduce the gain applied to the wanted sound signal when the level of the wanted sound signal after the gain has been applied exceeds the level of the detected ambient noise signal by the certain threshold, and wherein the variable gain amplifier is adapted to increase the gain applied to the wanted sound signal when the level of the wanted sound signal after the gain has been applied does not exceed the level of the detected ambient noise signal by the certain threshold.

18. A system as claimed in claim 17, wherein the variable gain amplifier is adapted to apply changes to the gain incrementally.

19. A system as claimed in claim 17, wherein the variable gain amplifier is adapted to apply hysteresis to changes in the gain.

20. A system as claimed in claim 16, wherein the adder is adapted to ensure that the total level of the wanted sound signal after the gain has been applied and of the detected ambient noise signal do not exceed a second threshold, to avoid saturating the speaker to which they are applied.
